(19) United States
(12) Patent Application Publication
(10) Pub. No.: US 2013/0036641 A1
(43) Pub. Date: Feb. 14, 2013

(54) Rotating Label Advertising Media Presentation System

(71) Applicant: Stephen M. Key, Modesto, CA (US)

(72) Inventor: Stephen M. Key, Modesto, CA (US)

(21) Appl. No.: 13/584,701

(22) Filed: Aug. 13, 2012

Related U.S. Application Data
(60) Provisional application No. 61/522,409, filed on Aug. 11, 2011.

(51) Int. Cl. G09F 3/10; G06K 19/06; G09F 3/02

(52) U.S. Cl. 40/638; 40/671; 235/494

(57) ABSTRACT

The present application is directed to systems and methods for a rotating advertising label for a container. One or more advertisements may be displayed on a base label. A portion of the base label may be visible through a transparent window in an opaque rotating top label. Rotation of the top label may cause the transparent window to display any combination or the advertisements.

### CROSS-REFERENCE TO RELATED APPLICATIONS

The present application claims priority to provisional U.S. Patent Application Ser. No. 61/522,409, filed on Aug. 11, 2011, titled “Method and Device for Presenting Advertising Media Content on Packaging,” which is hereby incorporated by reference in its entirety.

### FIELD OF THE INVENTION

The present application is directed generally to labels, and more specifically to label system for presenting adverting media on a consumer product container.

### BACKGROUND

Containers for consumer products have a limited amount of outer surface area for placement of labels on the container. This may pose a challenge to manufacturers of these consumer products to fit all of the information they want to deliver to the consumer, or are required by law to deliver to the consumer, in this limited area.

Product packaging for bottles and cans in particular has become has become increasingly expensive. Manufacturers of consumer products have gone to great lengths to decrease packaging costs, such as decreasing the thickness of plastic containers, changed packaging materials, and changing the size and types of caps. As a result of these cost pressures, the packaging industry has become very competitive. Manufacturers are continuing to search for more cost effective packaging solutions.

Traditional forms of advertising such as television, radio, and print media as well as emerging advertising mechanisms such as online pay-per-click and banner advertisements can be prohibitively expensive. These types of advertising may lack consumer interaction and precise targeting, leading to consumer ambivalence.

### SUMMARY

The present application is directed to systems and methods for a rotating advertising label for a container. An exemplary advertising label system may comprise a base label having a back surface and a front surface, with at least a first and a second advertisement on the front surface. The rotating label advertisement system may further comprise an opaque rotating top label covering at least a portion of the front surface of the base label. One or more transparent windows may be located within the opaque rotating top label such that at least one of the first and second advertisements is visible through the transparent window. Rotation of the top label may cause the other of the first and second advertisements to be visible through the transparent window.

According to additional exemplary embodiments, the present application may be directed to methods for displaying advertisements on a container. An exemplary method may comprise adhering a base label having a back surface and a front surface to the container, and displaying at least a first and a second advertisement on the front surface. At least a portion of the front surface of the base label may be covered by an opaque rotating top label. One or more transparent windows may be placed within the opaque rotating top label, such that at least one of the first and second advertisements may be visible through the transparent window.

### BRIEF DESCRIPTION OF THE DRAWINGS

FIG. 1 is a front view of an exemplary label according to various embodiments.

FIG. 2 is a back view of an exemplary label according to various embodiments.

FIG. 3 is a front view of an exemplary label according to various embodiments.

FIG. 4 is a back view of an exemplary label according to various embodiments.

FIG. 5A illustrates a leading edge of an exemplary label affixed to a container according to various embodiments.

FIG. 5B illustrates an exemplary label secured about a container according to various embodiments.

FIG. 6 illustrates an exemplary label secured about a container according to various embodiments.

FIG. 7 illustrates an exemplary base label secured about a container according to various embodiments.

FIG. 8 illustrates a leading edge of an exemplary top label affixed to an exemplary base label according to various embodiments.

FIG. 9 illustrates an exemplary top label affixed to an exemplary base label and partially wrapped about a container according to various embodiments.

FIG. 10 illustrates an exemplary top label with a window affixed to an exemplary base label and partially wrapped about a container according to various embodiments.

FIG. 11 illustrates an exemplary top label with a window secured about a container and a portion of a base label visible through the window according to various embodiments.

FIG. 12 is a front view of a base label according to various embodiments.

FIG. 13 is a front view of a top label with a transparent window according to various embodiments.

FIG. 14 illustrates an exemplary base label secured about a container according to various embodiments.

FIG. 15A illustrates an exemplary base label and top label secured about a container according to various embodiments.

FIG. 15B illustrates an exemplary base label and top label secured about a container according to various embodiments.

FIG. 15C illustrates an exemplary base label and top label secured about a container according to various embodiments

FIG. 16 illustrates an exemplary base label and top label with multiple transparent windows secured about a container.

FIG. 17 illustrates an exemplary base label and top label with multiple transparent windows secured about a container.

FIG. 18 illustrates an exemplary base label and top label with multiple transparent windows secured about a container.

FIG. 19 illustrates an exemplary base label and top label secured about a container according to various embodiments.

FIG. 20 is an exemplary flow diagram of a method for displaying advertisements on a container according to various embodiments.

### DETAILED DESCRIPTION

The present application is directed to systems and methods for a rotating advertising label for a container. An exemplary advertising label system may comprise a base label having a back surface and a front surface, with at least a first and a second advertisement on the front surface. The rotating label advertisement system may further comprise an opaque rotating top label covering at least a portion of the front surface of the base label. One or more transparent windows may be located within the opaque rotating top label such that at least one of the first and second advertisements is visible through the transparent window. Rotation of the top label may cause the other of the first and second advertisements to be visible through the transparent window.

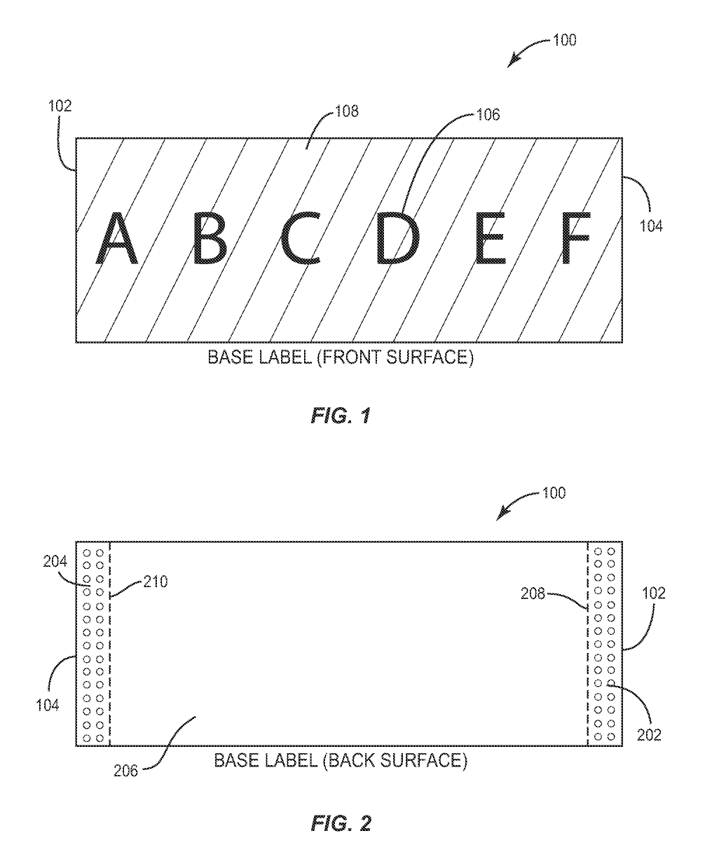

FIG. 1 illustrates various embodiments of a front surface 108 of a base label 100 for an object, such as a medication container, according to various embodiments. The base label 100 comprises a leading edge 102 and a trailing edge 104. While the leading edge 102 is oriented to the left and the trailing edge is oriented to the right as presented in FIG. 1, the orientation of the leading edge 102 and the trailing edge 104 could be reversed depending on which edge is first applied to the object. Both orientations are within the scope of the present disclosure. Base label front surface 108 may comprise writing, indicia, or other printed label information 106 thereon.

As used herein, the leading edge refers to the first edge to be affixed to the object and the trailing edge refers to the second edge to be affixed to the object or the overlapping leading edge. Depending on the orientation of the label and the object when the label is affixed to the object, either edge of the label may be the leading edge. The orientations presented in the figures are for convenience and are not intended to be limiting in any way.

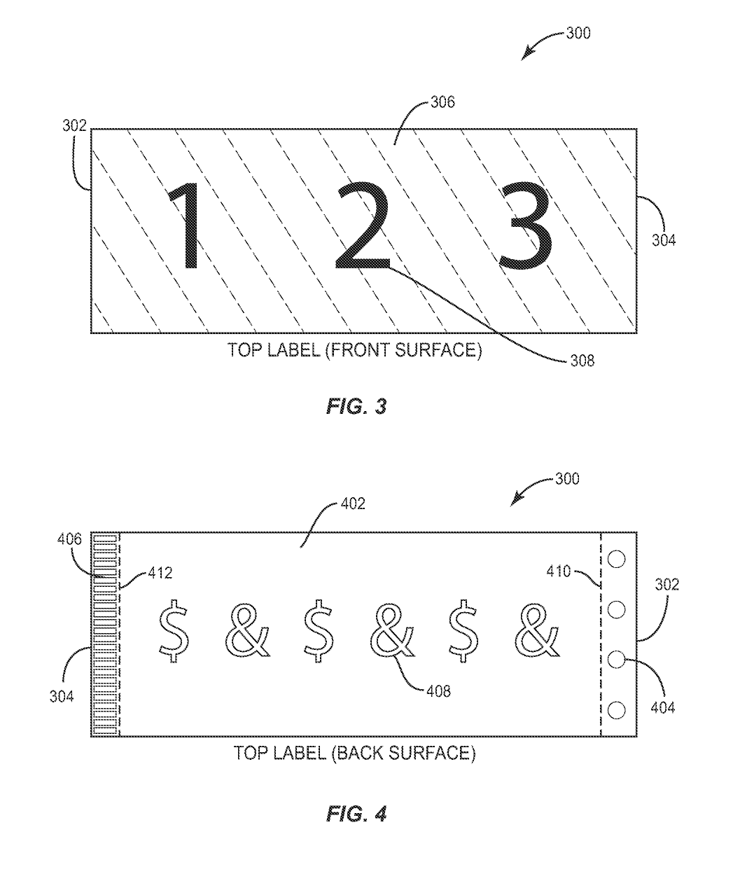

FIG. 2 illustrates various embodiments of a back surface 206 of the base label 100. In various embodiments, the base label back surface 206 comprises two strips of adhesive 202 and 204 on or immediately adjacent to the leading and trailing edges, 102 and 104, respectively. Base label leading edge adhesive 202 may have a boundary 208 defined as its limit on the base label back surface 206. Base label trailing edge adhesive 204 may also have a boundary 210. While FIG. 2 illustrates that the adhesive strips 202 and 204 are generally close to the base label leading and trailing edges 102 and 104, respectively, it is understood that the adhesive strips 202 and 204 may be continuous or discontinuous, and may extend across any portion of the base label back surface 206, including the entire base label back surface 206. In various embodiments, a length of the base label 100 may be selected to be slightly longer than a circumference of the object on which it is placed, such that the trailing edge 104 overlaps the leading edge 102, and the trailing edge 104 is affixed to the leading edge 102. In various embodiments, the length of the base label 100 may be selected to be approximately the same as the circumference of the object on which it is placed, such that the leading edge 102 and the trailing edge 104 do not overlap.

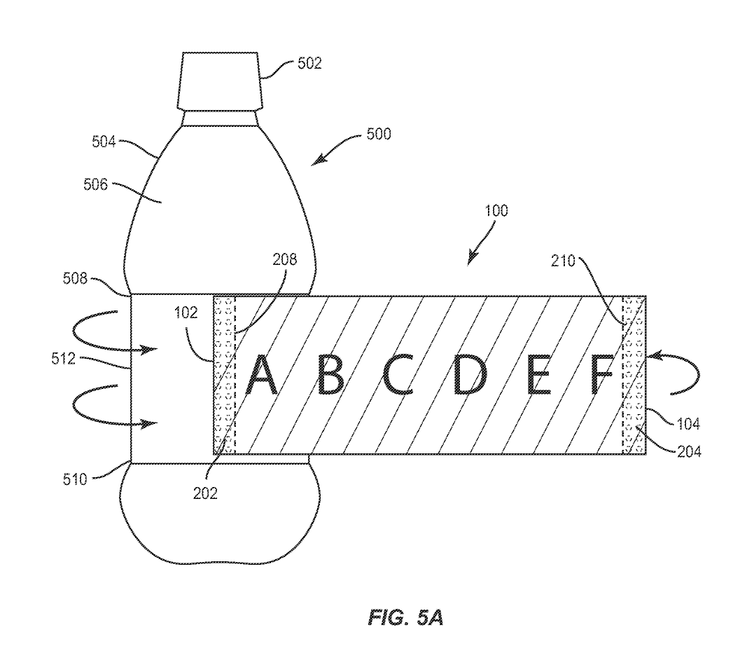

FIG. 3 illustrates various embodiments of a front surface 306 of a top label 300. Top label 300 comprises a leading edge 302 and a trailing edge 304, and indicia 308 may be imprinted on the top label front surface 306.

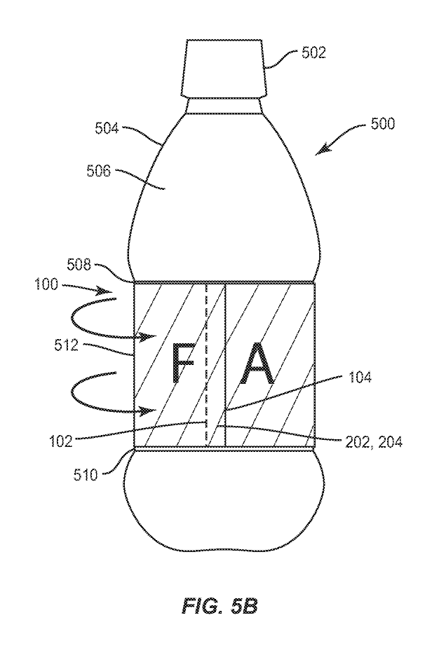

Various embodiments of a back surface 402 of the top label 300 are illustrated in FIG. 4. The top label back surface 402 may comprise various indicia 408 printed thereon, as well as two strips of adhesive 404 and 406 on or immediately adjacent to the leading and trailing edges, 302 and 304, respectively. Top label leading edge adhesive 404 may have a boundary 410 defined as its limit on the top label back surface 402. Top label trailing edge adhesive 406 may also have a boundary 412. While FIG. 4 illustrates that the adhesive strips 404 and 406 are generally close to the top label leading and trailing edges 302 and 304, respectively, it is understood that the adhesive strips 404 and 406 may be continuous or discontinuous, and may extend across any portion of the top label back surface 402, including the entire top label back surface 402. In various embodiments, the adhesive strips 404 and 406 are confined to areas near the leading and trailing edges 302 and 304, respectively, so as not to obscure or interfere with the top label back surface indicia 408.

The base label adhesive 202, 204 and the top label adhesive 404, 406 may be applied in a variety of patterns as can be appreciated by one skilled in the art. The adhesive 202, 204, 404, 406 may be applied in in strips, dots, droplets, circles, rectangles, squares, triangles, lines, and the like, as well as combinations of patterns.

A length of the top label 300 may be selected to be slightly longer than a circumference of the object on which it is placed, such that the top label trailing edge 304 overlaps the top label leading edge 302, and the top label trailing edge 304 is affixed to the top label leading edge 302. In various embodiments, the length of the top label 300 may be selected to be approximately the same as the circumference of the object on which it is placed, such that both the leading edge 302 and the trailing edge 304 do not overlap and are affixed to the base label front surface 108.

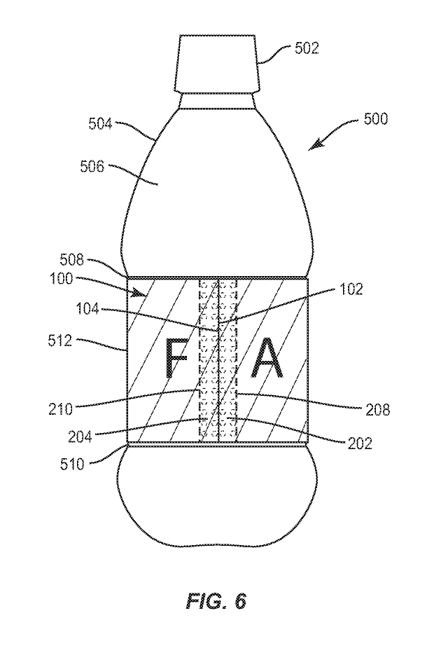

FIG. 5A illustrates the application of the base label 100 to an exemplary container 500 according to various embodiments. The container 500 may be a glass or plastic bottle, or other type of container such as a metal can or a cardboard receptacle. The container may be round, rectangular, square, or any other shape known in the art. The term “container” is used here for convenience to describe exemplary embodiments. It is understood that the container may be any object, including non-containers. Container 500 may comprise a closure 502 removably secured to a body 504. Various embodiments of the body 504 may have an exterior surface 506 that comprises a upper label panel 508, a lower label panel 510, and a recessed area 512 interposed between the upper label panel 508 and the lower label panel 510. As discussed below, the base label 100 may be applied to the container 500 at the recessed area 512 between the upper label panel 508 and the lower label panel 510.

In various embodiments, the closure 502 may function to seal an opening in the container 500, such as the opening of a beverage container 500. The closure 502 may be of any type known in the art to seal the container 500 to help preserve the product in the container 500 and to prevent spills. The closure may be constructed of any material suitable for the purpose, such as plastic, metal, or glass. For example, in certain embodiments, the container 500 may be a plastic container 500 for a beverage. The closure 502 may comprise a removable and resealable screw-on plastic cap 502. Closures 502 for plastic containers 500 may also comprise a pop-up cap that opens when pulled upward and closed when pressed downward, or a flip-top cap.

In various embodiments, the container 500 may be a glass container 500 for a beverage. In addition to the screw-on plastic caps described above, the closure 502 may comprise a metal closure 502 such as a crown cap that is crimped in place on the opening of the container. In various embodiments, the crown cap closure 502 may have a plurality of “teeth” extending outward as a result of the crimping process that may also serve to anchor a device to remove the crown cap closure 502.

According to various embodiments, the closure 502 may also comprise a liner that covers at least a portion of an interior surface of the closure 502. The closure may be constructed of any suitable material, such as a polymeric material (such as polyethylene, polyvinyl chloride, styrene, rubber, and the like) or cork. The liner may be clear or opaque, and may be suitable to accept printing thereon.

In various embodiments, the top label 300 may be rotatable about the base label 100, as discussed below. In these embodiments, the upper label panel 508 and lower label panel 510 may function to restrict upward and downward movement of the top label 300 in relation to the container 500 such that the top label 300 generally remains in a position covering at least a portion of the base label 100.

FIG. 5B illustrates the container 500 with the base label 100 affixed to the container 500. Initially, as illustrated in FIG. 5A, base label leading edge 102 is placed in contact with the recessed surface 512 of the container 500 and affixed to the container 500 by the leading edge adhesive strip 202. With relative motion between the container 500 and the base label 100, the base label 100 may be wrapped around the container 500 with the base label trailing edge 104 now overlapping the base label leading edge 102 such that the leading edge adhesive strip 202 holds the base label leading edge 102 to the container 500 while the trailing edge adhesive strip 204 holds the base label trailing edge 104 to the overlapped base label leading edge 102.

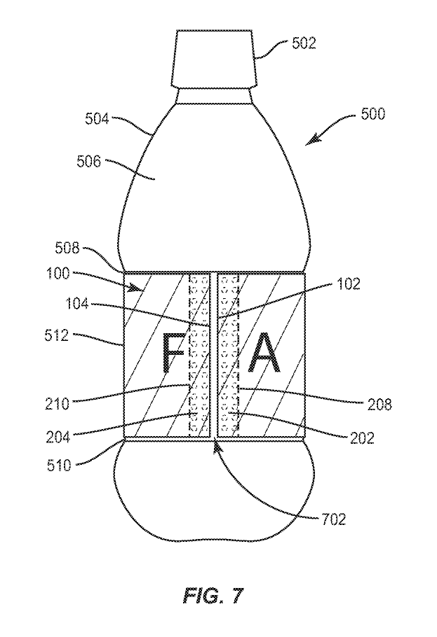

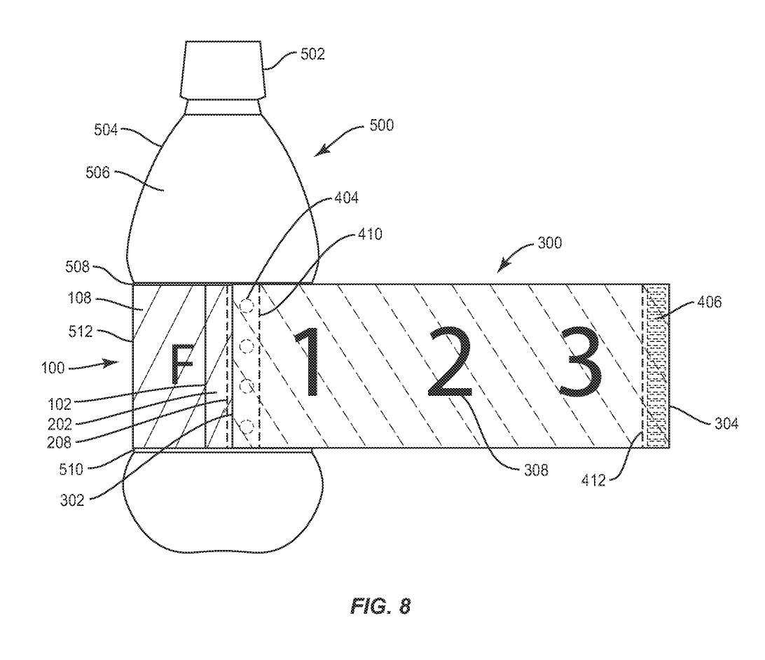

In various embodiments as illustrated in FIG. 6, the length of the base label 100 may be substantially the same as a circumference of the recessed surface 512 of the container 500, which may allow the base label leading edge 102 and base label trailing edge 104 to abut rather than overlap. However, it is also possible that the length of the base label 100 may be shorter than the circumference of the recessed surface 512, resulting in a gap 702 between the base label leading edge 102 and the base label trailing edge 104 when the base label 100 is affixed to the recessed surface as illustrated in FIG. 7. In both of these instances, the base label trailing edge adhesive strip 204 may adhere to the recessed surface 512 of the container 500, rather than the base label leading edge 102.

In various embodiments, the base label adhesive strips 202, 204 may comprise a permanent adhesive. In general, a permanent adhesive is one that does not readily release from a surface to which it adheres after the adhesive dries or cures. Using the base label 100 as an example, the permanent adhesive 202, 204 will tend not to release from the recessed surface 512, nor will it tend to release the base label leading edge 102 or trailing edge 104 once dried or cured. In order to remove the base label from the recessed surface 512, the base label 100 may have to be torn from the adhesive, or the adhesive layer 202, 204 may have to be fractured which may leave some of the adhesive on the recessed surface 512 and some of the adhesive on the base label leading edge 102 or trailing edge 104. Once the surfaces affixed with the permanent adhesive are separated, they may not be reattached.

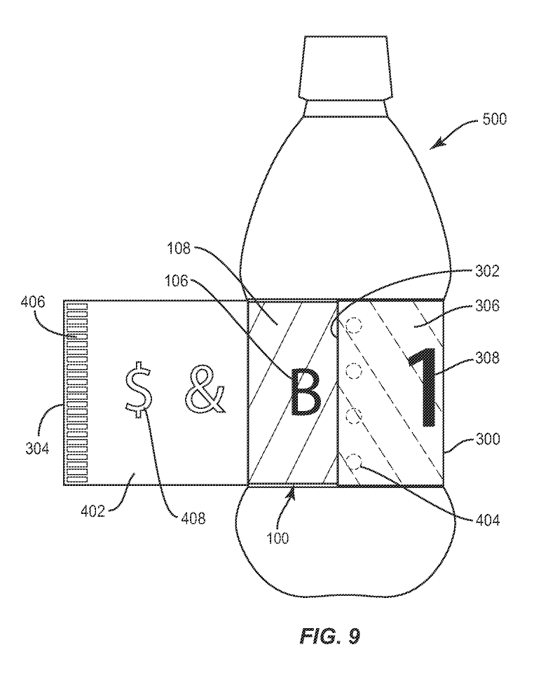

In FIG. 8, the base label 100 is already affixed to the recessed surface 512 of the container 500, and the application of the top label 300 over the base label 100 is illustrated according to various embodiments. The top label leading edge 302 may be placed in contact with any portion of the base label front surface 108 and affixed to the base label front surface 108 by the top label leading edge adhesive strip 404. With relative motion between the container 500 and the top label 300, the top label 300 may be wrapped around the container 500 with the top label trailing edge 304 now overlapping the top label leading edge 302 such that the top label leading edge adhesive strip 404 holds the top label leading edge 302 to the base label 100 while the top label trailing edge adhesive strip 406 holds the top label trailing edge 304 to the overlapped top label leading edge 302.

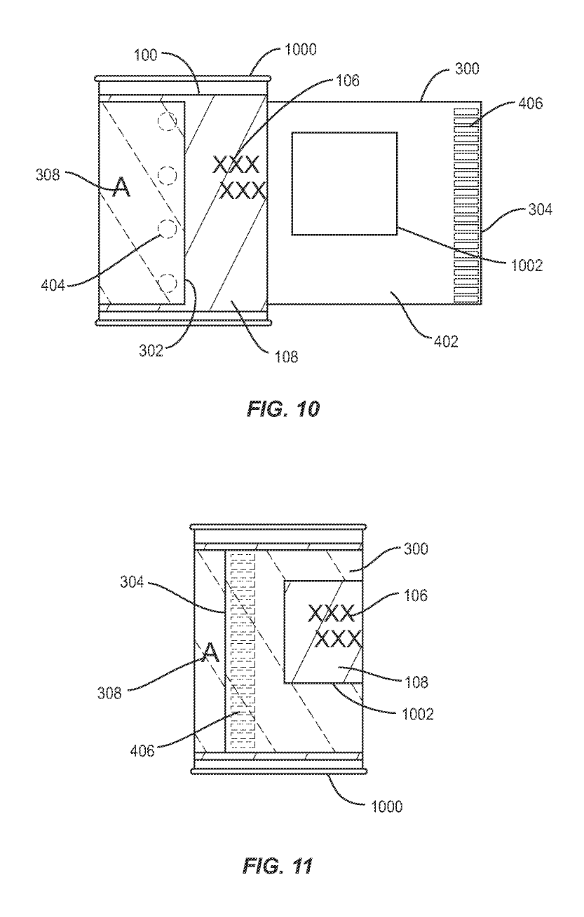

FIG. 9 illustrates the operation of the base label 100 and the top label 300 according to various embodiments. Beginning with the container 500 with the base label 100 and the top label 300 in place as shown, for example, in FIG. 6, the top label trailing edge 304 may be detached from the top label leading edge 302 and at least partially peeled back as shown in FIG. 9. The combination of the base label 100 and the top label 300 in this configuration increases the amount of surface area available for viewing by a consumer or user of the container 500. Prior to detaching the top label trailing edge 304, the consumer may view the top label front surface 306. Upon detaching the top label trailing edge 304, the consumer may now view the top label back surface 402 and the base label front surface 108 in addition to the top label front surface 306.

One of at least three types of adhesive may be used for the top label leading edge adhesive 404. A first type of adhesive is the permanent adhesive as described above for the base label 100. When a permanent adhesive is used for the top label leading edge adhesive 404, the top label leading edge generally cannot be detached without inflicting damage to one or both of the top label 300 or the base label 100. This may be desirable for various embodiments where the top label 300 is not intended to be removed from the container 500.

A second type of adhesive that may be used for the top label leading edge adhesive 404 is a releasable adhesive. A releasable adhesive is one that will release from a surface to which it is attached once a sufficient mechanical force is applied. A releasable adhesive may be used, for example, when the top label back surface 402 comprises a coupon for a subsequent purchase of a product. The releasable adhesive may allow the consumer to easily remove the top label 300 for later use. In various embodiments, the releasable adhesive may be a breakaway adhesive. A breakaway adhesive may have limited ability to withstand shear stresses. Shear stresses may cause the adhesive bond created between the label (e.g., top label 300) and the surface to which it is affixed (e.g., the base label 100 or container 500) to fail along the adhesive. In general, a releasable or breakaway adhesive may not re-attach to a surface once removed.

A third type of adhesive that may be used for the top label leading edge adhesive 404 is a resealable adhesive. A resealable adhesive may release from a surface to which it is attached once a sufficient mechanical force is applied, similar to the releasable adhesive described above. However, the resealable adhesive may be re-attached to a surface by applying pressure. A resealable adhesive may be desirable when the top label back surface 402 or the base label front surface 108 comprise information that may be needed only on occasion. Thus, the consumer or user may detach the top label 300 when the information is needed, then re-attach the top label 300.

In various embodiments, the top label trailing edge adhesive 406 may be a releasable adhesive or a resealable adhesive, depending on the intended use of the top label 300. As described above, if the surfaces 108, 402 comprise information that is intended to stay with the container, the top label trailing edge adhesive 406 may be a resealable adhesive. In contrast, if the top label 300 is intended to be removed from the container 500, a releasable adhesive may be desirable.

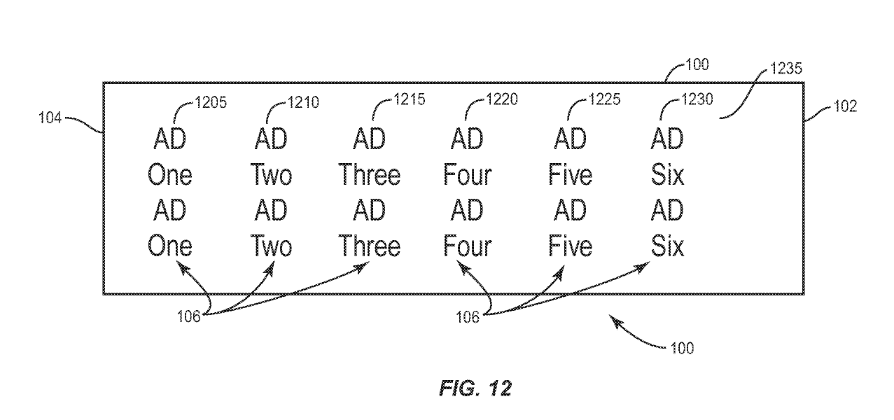

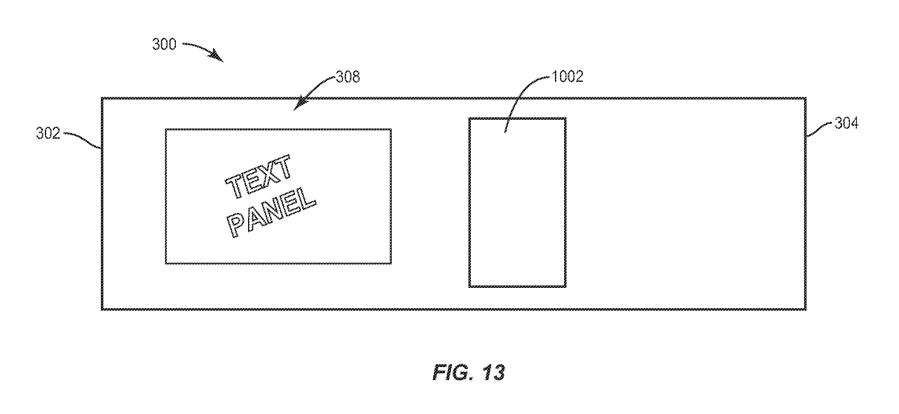

FIG. 10 illustrates various embodiments of the top label 300 comprising a window 1002. The window 1002 may comprise a void in the top label 300 such that a portion of the base label 100 may be visible through the window. In various embodiments, the window 1002 may have a transparent covering (not shown). In various other embodiments, the window may comprise a transparent section of the top label 300 itself rather than a void. FIG. 10 illustrates the top label 300 partially wrapped about a container 1000, and base label 100 already in place on the container 1000. As shown, the top label leading edge adhesive 404 maintains the top label 300 coupled to the base label 100. The top label 300 may then be moved from the position illustrated in FIG. 10 to the position illustrated in FIG. 11 to secure the top label 300 about the container 1000. Top label trailing edge adhesive 406 may couple to the top label leading edge 302 if the top label leading edge 302 and trailing edge 304 overlap; otherwise, the top label trailing edge adhesive 406 may be coupled to the base label front surface 108.

Once the top label 300 is in position on the container 1000 as illustrated in FIG. 11, at least a portion of the base label front surface printed label information 106 may be visible through the window 1002. This may allow viewing of a first portion of the base label 100 without removing the top label 300. In various embodiments, the top label leading edge adhesive 404 may be a breakaway adhesive. Rotation of the top label 300 relative to the base label 100 may exert shear stresses on the breakaway adhesive, causing the adhesive bond affixing the top label leading edge 302 to the base label 100 to fail. The top label 300 may then be freely rotatable about the base label 100, and a second portion of the base label 100 may be visible when the top label 300 is rotated to a second position. The window 1002 may be rectangular as illustrated in FIGS. 10 and 11, or any other shape as needed for a particular application. For example, the window 1002 may be a slit that reveals an alphanumeric string on the base label 100. In various embodiments, the top label 300 may comprise more than one window 1002. Various embodiments in which the top label trailing edge adhesive 406 is a resealable or releasable adhesive may allow the top label 300 to be peeled back to reveal the top label back surface 402 and essentially the entire base label front surface 108 or to be removed from the container 1000, in addition to being rotatable.

One skilled in the art will readily recognize that labels may be applied to containers using a variety of methods and that there may be a variety of single-label and multi-label systems other than those described above. Any such application methods or label systems may be used with the present disclosure. The above descriptions are exemplary and not to be construed as limiting in any way. Examples of other application methods and label systems may be disclosed in U.S. Pat. Nos. 5,884,421, 6,086,697, 6,237,269, 6,402,872, 6,631,578, 6,649,007, 7,087,298, and 7,172,668.

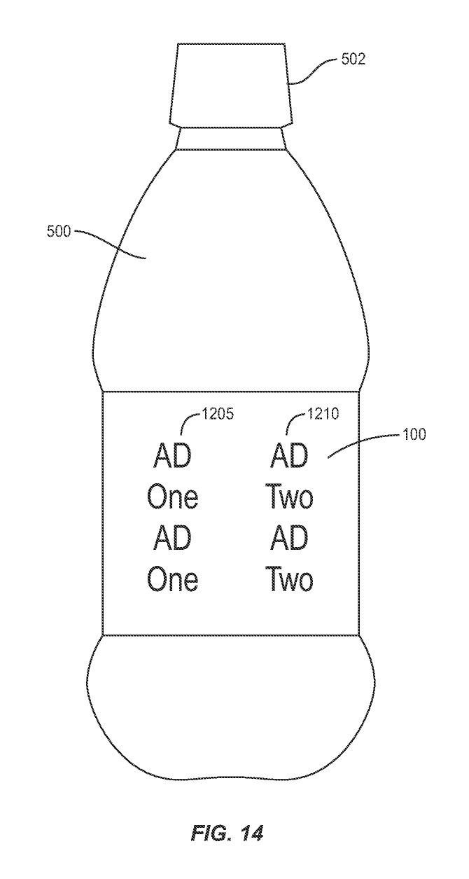

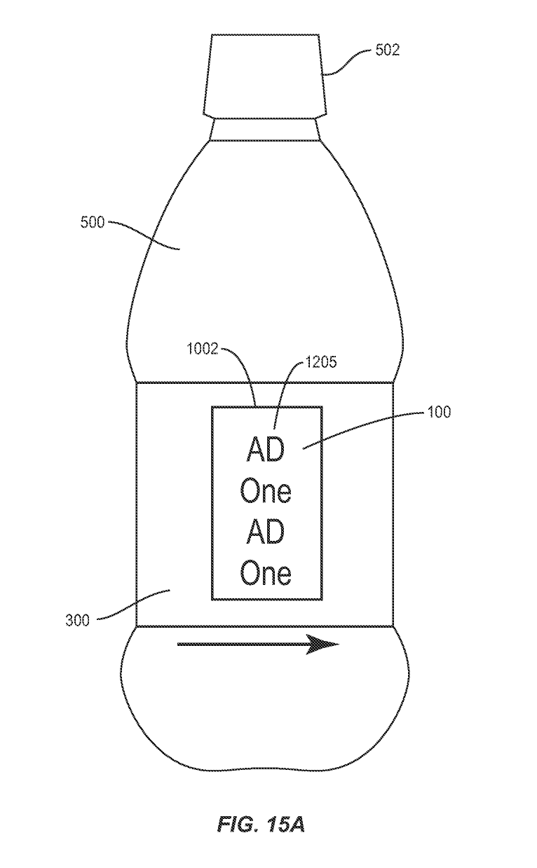

In various embodiments, the base label 100 and the rotatable top label 300 may comprise an interactive and coordinated label system for presenting advertising content on a container 500. FIGS. 12 and 13 illustrate various embodiments of a base label 100 and top label 300, respectively, that may comprise the label system. The printed label information (or indicia) 106 on the base label 100 may comprise a plurality of advertising content. According to the various embodiments of FIG. 12, the printed label information 106 may comprise a plurality of individual advertisements 1205-1230. The advertisements 1205-1230 may all be unique, or two or more may be identical.

While FIG. 12 illustrates the advertisements 1205-1230 each vertically oriented and spaced apart horizontally along a length of the base label 100, any orientation and spacing, whether regular or random, may be used according to various embodiments. In addition, a portion of the advertisements 1205-1230 may be positioned according to one scheme, while another portion of the advertisements 1205-1230 may be positioned according to a second scheme.

The manufacturer of the product packaged in the container 500 may use the advertisements 1205-1230 as a marketing tool for their other products, products of another division within the company, or even for products of a different or unique advertiser. For example, the manufacturer of a soft drink may know that a significant portion of the consumers buying the soft drink also purchase energy drinks and may use one or more of the advertisements 1205-1230 to promote a new energy drink. In another example, the manufacturer of the soft drink may sell advertising space to a third party that sells snack foods, as this combination of consumer products may enjoy a symbiotic relationship wherein increased sales of snack foods leads to a proportionate increase in soft drink sales. In yet another example, the advertisements 1205-1230 may be for a product unrelated to the soft drink, but the manufacturer of the unrelated product desires to reach the consumers of the soft drink.

In still other embodiments, the advertisements 1205-1230 may be for an event such as an upcoming theatrical movie, concert, store opening, and the like. Likewise, the advertisement 1205-1230 may be for a service, such as medical services, plumbing services, and construction services, or messages to promote social awareness or political messages. As will be evident to one skilled in the art, the advertisements 1205-1230 may be for any type of product, service, or message as is known in the art or may become known.

In various embodiments, the form of the advertisements 1205-1230 may comprise any combination of alphanumeric characters, pictures, graphics, symbols, images, and the like. One skilled in the art will recognize that the scope of the present disclosure is not limited by the form of the advertisements 1205-1230.

The top label 300 may include indicia 308 comprising instructions for how to use the label system. Indicia 308 may also comprise product-related information, safety-related information, manufacturer-related information, and the like. In various embodiments, the top label 300 may contain a transparent window 1002 as described previously (see FIG. 10) and may be rotatable about the container 500. The transparent window 1002 may reveal a first portion of the printed label information 106 (e.g., first advertisement 1205) when rotated to a first position about the container 500, and may reveal a second portion of the printed label information 106 (e.g., second advertisement 1210) when rotated to a second position about the container 500.

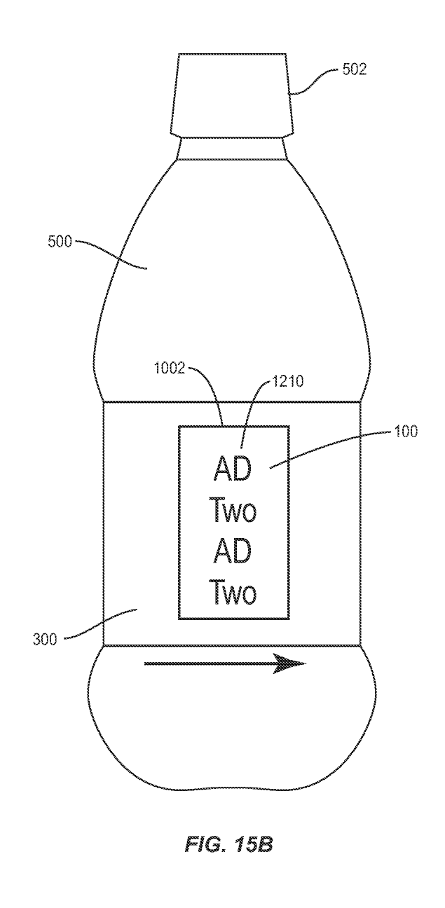

FIGS. 14 through 19 illustrate the base label 100 and top label 300 on a beverage container 500 according to various embodiments. The use of a beverage container in these figures is illustrative and does not limit the scope of the present disclosure. The base label 100 and top label 300 may be used on any type of container (e.g., bottles, cans, dispensers, cartons, boxes, bags) known in the art used for packaging any type of product (e.g., foods, drinks, medicines, health and beauty products) known in the art. In FIG. 14, the base label 100 is positioned on the container 500 such that the advertisements 1205-1230 are positioned around at least a portion of the circumference of the container 500. The printed label information 106 may comprise the advertisements 1205-1230.

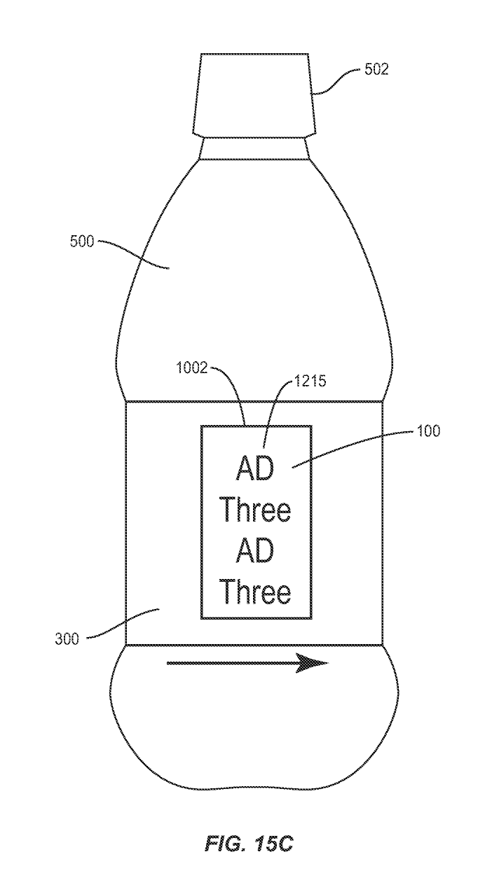

FIG. 15A illustrates the rotatable top label 300 in place over the base label 100 on the container 500 according to various embodiments. The top label 300 may be positioned such that a first portion of printed label information 106 is visible through the transparent window 1002. As shown in FIG. 15A, the first portion of printed label information 106 comprises at least in part the first advertisement 1205. The first advertisement 1205 (as well as any other advertisement 1210-1230 as illustrated in FIG. 12) may comprise any combination of letters, numbers, and symbols; may spell out words or phrases in any language; may be numbers that correspond to a numeral system other than base 10, such as binary; or any other alphanumeric representation known in the art. As described previously, the top label 300 may be applied such that the top label 300 is rotatable around a circumference of the container 500. In FIG. 15B, the top label 300 has been rotated in the direction of the arrow revealing at least a second portion of the printed label information 106 through the transparent window 1002 in the top label 300. The second portion of the printed label information 106 may comprise the second advertisement 1210. Similarly, FIG. 15C illustrates the top label 300 further rotated in the direction of the arrow, thus revealing a third portion of the printed label information 106 through the transparent window 1002 of the top label 300. The third portion of the printed label information 106 may comprise a third advertisement 1215. Further rotation of the top label 300 may cause additional advertisements 1205-1230. Although FIGS. 15A-15C illustrate a single portion of the printed label information 106 visible through the transparent window 1002, two or more portions of the printed label information 106 may simultaneously be visible through the transparent window 1002 in various embodiments. For example, the transparent window 1002 may be sized to reveal both the second advertisement 1210 and the third advertisement 1215.

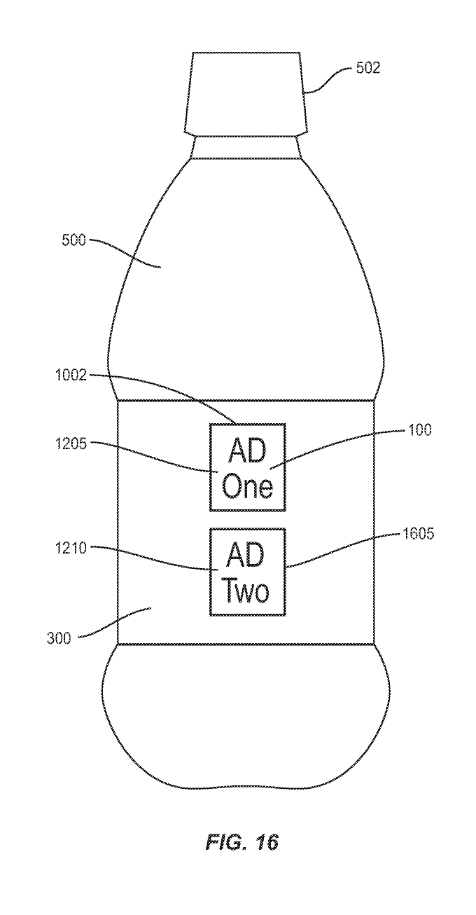

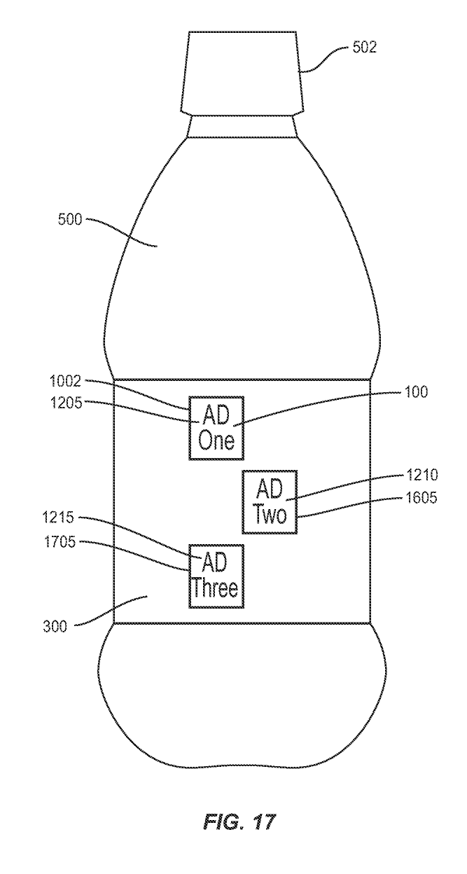

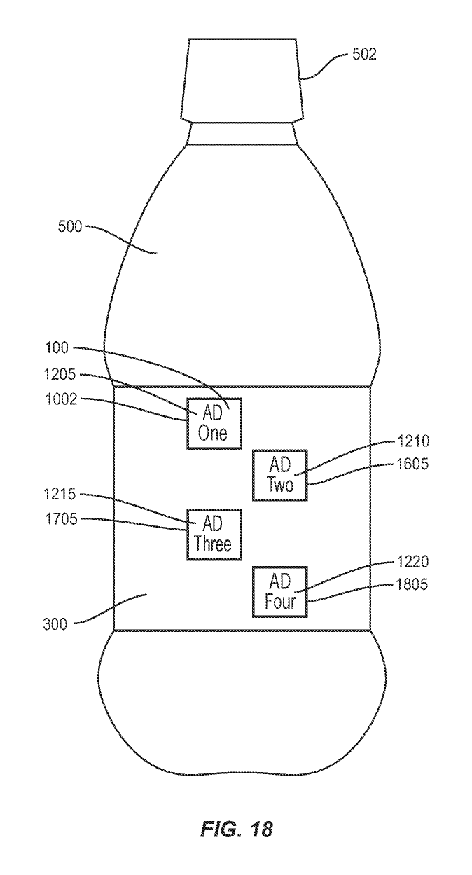

FIGS. 16-18 illustrate various embodiments of the top label 300 comprising more than one transparent window 1002. In FIG. 16, the top label 300 comprises the transparent window 1002 and a second transparent window 1605. FIG. 17 illustrates various embodiments with the addition of a third transparent window 1705, and a fourth transparent window 1805 is illustrated in FIG. 18. Any number, size and placement of transparent windows 1002, 1605, 1705, 1805 is within the scope of the present disclosure, and in some embodiments the surface area of the base label 100 revealed by the transparent windows 1002, 1605, 1705, 1805 may be as much as 75 percent or more of the total surface area of the front surface 108 of the base label 100.

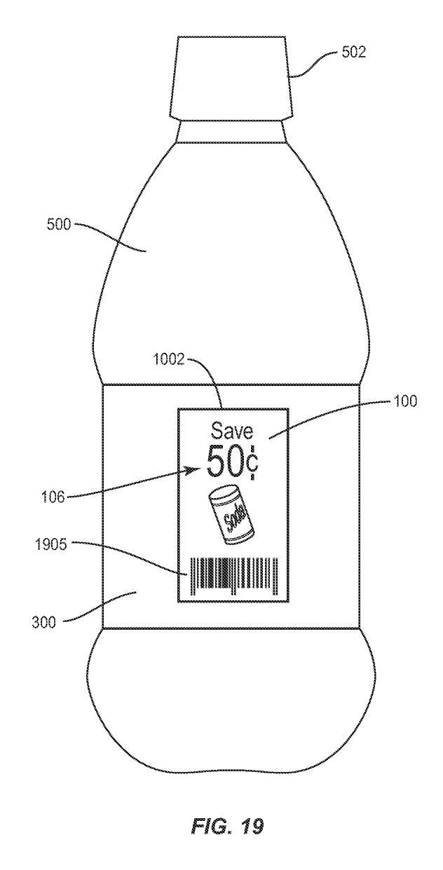

Various embodiments may increase user interaction with the product and the manufacturer of the product. FIG. 19 illustrates various embodiments of the base label 100 and the top label 300 in which one or more interactive advertisements may be displayed in the transparent window 1002. For example, at least a portion of the advertisement 1205-1230 may comprise an interactive graphic 1905. The interactive graphic 1905 may comprise a bar code as illustrated in FIG. 19. In various embodiments, the bar code may be scanned at the point of purchase and provide a discount on the purchase or other benefit such as an entry into a contest. At least a portion of the advertisement 1205-1230 or the interactive graphic 1905 may comprise a redeemable coupon.

In various embodiments, the interactive graphic 1905 may comprise any linear, 2-dimensional, or 3-dimensional indicia or code as known in the art that may be machine readable to cause an electronic device to execute a function when the interactive graphic 1905 is scanned by the electronic device. For example, the interactive graphic 1905 may comprise a High Capacity Color Barcode (HCCB) comprising a plurality of barcode shapes (e.g., triangles, circles, squares, diamonds) in combination with a plurality of colors per symbol. According to various embodiments, the interactive graphic 1905 may also comprise a Quick Response (QR) Code or a linear barcode.

In addition to the interactive graphic 1905 illustrated in FIG. 19, other indicia, codes, or symbols, whether linear, 2-dimensional, 3-dimensional, color, or monochrome, as are known in the art may also be used in various embodiments. For example, the interactive graphic 1905 may comprise any or any combination of:
3-DI, a 2-dimensional matrix of circular symbols;
ArrayTag, a 2-dimensional matrix of groups of hexagonal symbols;
Aztec Code, a 2-dimensional square matrix of square symbols;
Codablock, a 2-dimensional array of stacked linear codes;
Code 1, a 2-dimensional matrix of horizontal and vertical bars;
Code 16K, a 2-dimensional array of stacked linear codes;
Code 49, a 2-dimensional array of stacked linear codes;
ColorCode, a 2-dimensional color matrix of square symbols;
CP Code, a 2-dimensional square matrix of square symbols;
DataGlyphs, a 2-dimensional matrix of “/” and “\” marks;
Data Matrix, a 2-dimensional square matrix of square symbols;
Datastrip Code, a 2-dimensional matrix of square symbols;
Dot Code A, a 2-dimensional square matrix of dots;
hueCode, a 2-dimensional matrix of blocks of cells in varying shades of gray;
MaxiCode, a 2-dimensional square matrix of interlocking hexagonal symbols;
MiniCode, a 2-dimensional square matrix of square symbols;
PDF 417, a 2-dimensional matrix of a combination of linear barcodes and square symbols;
Snowflake Code, a 2-dimensional square matrix of dots;
SuperCode, a 2-dimensional matrix of a combination of linear barcodes and square symbols;
Ultracode, a color or monochrome 2-dimensional array matrix of variable length strips of pixel columns; and
3D Barcode, an embossed linear barcode of lines of varying height.

The interactive graphic 1905 described above represent a sampling of exemplary machine readable indicia currently available and are not to be construed as limiting in any manner. Other linear, 2-dimensional, and 3-dimensional codes, currently known or developed in the future, are within the scope of the present disclosure. Additionally, the interactive graphic 1905 may comprise any combination of machine readable indicia, as well as non-machine readable indicia.

The advertisement 1205-1230 may comprise a pictogram or other graphical representation according to various embodiments. The pictogram may provide a readily identifiable representation of a product, service or company. The pictogram may follow generally accepted national or international standards, or may comprise symbols or icons developed specifically for the product or service advertised. In at least some embodiments, the advertisement 1205-1230 may comprise wording to augment the pictogram.

One skilled in the art will readily recognize that any combination of pictograms, icons, symbols, graphics, photographs, drawings, designs, and wording, either individually or in any combination or arrangement, are within the scope of the present disclosure. In addition, any color or combination of colors, backgrounds, and borders are within the scope of the present disclosure

In various embodiments, the interactive graphic 1905 may comprise a URL for a website. Although not shown, the URL may also be placed on the base label 100 such that the URL is visible through the transparent window 1002. The URL may motivate the consumer to visit a website designated by the URL. The website may display a variety of marketing information to the consumer about the product in the container 500 or other products. In various embodiments, the consumer may rotate the top label 300 such that additional interactive graphics 1905 are revealed.

In various embodiments, the interactive graphic 1905 may be machine readable. The consumer may use any electronic device, such as a smartphone, to read or scan the interactive graphic 1905. The smartphone may comprise an application that enables a reading or scanning function on the smartphone. Once the smartphone (or other electronic device such as a tablet computer or scanner coupled to a computer) reads or scans the interactive graphic 1905, the application may be configured to cause the smartphone to execute a function. The function executed by the smartphone may be to open a web browser program and direct the browser to a website designated by the interactive graphic 1905.

The top label 300 may comprise a dual ply (or multi-ply) construction in which a ply in contact with the base label 100 is a material selected for low sliding friction characteristics. The low sliding friction characteristics may enhance the ease of rotating and sliding the top label 300 about the base label 100. In various embodiments, the top label 300 ply in contact with the base label 100 may be coated with a substance to impart the low sliding friction characteristics.

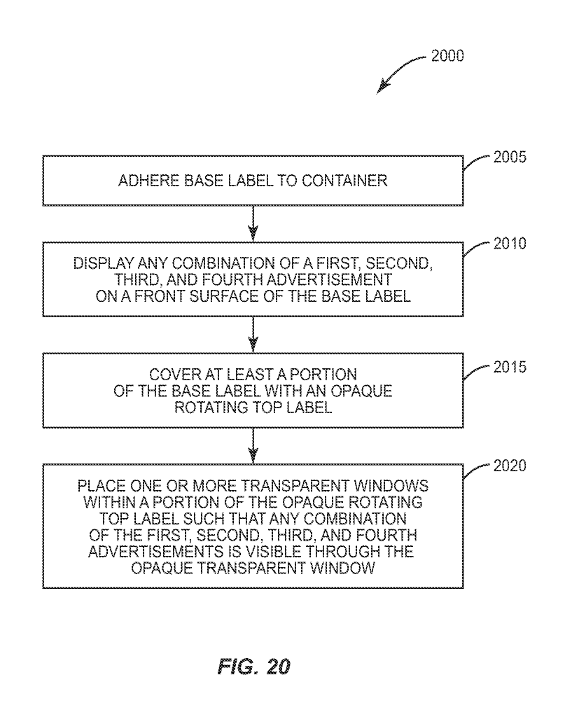

FIG. 20 illustrates a general flow chart of various embodiments of a method 2000 for displaying advertisements on a container. At step 2005, a base label 100 may be adhered to a container 500. The base label 100 may have a back surface 206 and a front surface 108. Any combination of a first, a second, a third, and a fourth advertisement 1205-1230 may be displayed on the front surface 108 of the base label 100 (step 2010). Each of the first, second, third, and fourth advertisements 1205-1230 may be associated with a different or unique advertiser. At step 2015, at least a portion of the base label 100 may be covered with an opaque rotating top label 300. In various embodiments, the base label 100 may be coupled to the container 500 while the opaque top label 300 is free to rotate about the base label 100. One or more transparent windows 1002 may be placed within a portion of the opaque rotating top label 300 at step 2020 such that any combination of the first, second, third, or fourth advertisements 1205-1230 is visible through the transparent window 1002. As the top label 300 is rotated about the base label 100, the first, second, third, and fourth advertisements 1205-1230 may alternately be visible through the transparent window 1002. In various embodiments, more than one of the advertisements 1205-1230 may be visible through the transparent window 1002. For example, the first and second advertisements 1205, 1210 may simultaneously be visible through the transparent window 1002, or the second and third advertisements 1210, 1215 may simultaneously be visible through the transparent window 1002. In various other embodiments, the top label 300 may comprise multiple windows 1002 such that multiple advertisements 1205-1230 may be visible simultaneously through the multiple windows 1002.

In various embodiments, the printed label information 106 may be imprinted, embossed, or molded directly on an outer surface of the container 500 in place of all or a portion of the base label 100. The imprinting or embossing may be carried out using any printing or image transfer method known in the art. In various embodiments, the printing or image transfer method may be an offset process in which an image is transferred from a plate to an intermediate carrier, then to the outer surface of the container 500. The offset process may also involve lithographic techniques. Other printing or image transfer methods may comprise, for example, flexography, pad printing, relief printing, rotogravure, screen printing, and electrophotography. According to various embodiments, the printed label information 106 may be digitally printed on the outer surface of the container 500 using, for example, inkjet printing or laser printing. Chemical printing technologies, such as blueprint or diazo print may also be used in various embodiments.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A rotating label advertising system for a container, the system comprising:
a base label adhered to the container, the base label having a back surface and a front surface;
at least a first and a second advertisement on the front surface of the base label;
an opaque rotating top label covering at least a portion of the front surface of the base label; and
a first transparent window within a portion of the opaque rotating top label, the first transparent window allowing at least one of the first and second advertisements to be visible through the first transparent window.

2. The system of claim 1, wherein each of the advertisements is associated with a different or unique advertiser.

3. The system of claim 1 further comprising a second transparent window within a portion of the opaque rotating top label, the second transparent window allowing at least one of the first and second advertisements to be visible through the second transparent window.

4. The system of claim 3, wherein each transparent window allows at least a portion of a single advertisement to be visible.

5. The system of claim 1, wherein at least one of the advertisements comprises a coupon.

6. The system of claim 1, wherein at least one of the advertisements comprises a pictogram.

7. The system of claim 1, wherein at least one of the advertisements comprises a machine readable indicia.

8. The system of claim 7, wherein the machine readable indicia is a bar code.

9. The system of claim 7, wherein the machine readable indicia is a quick response code.

10. A rotating label advertising system for a container, the system comprising:
a base label adhered to the container, the base label having a back surface and a front surface;
at least a first, a second, and a third advertisement on the front surface of the base label;
an opaque rotating top label covering at least a portion of the front surface of the base label; and
a first transparent window within a portion of the opaque rotating top label, the first transparent window allowing at least one of the first, second, or third advertisements to be visible through the first transparent window.

11. The system of claim 10, wherein each of the advertisements is associated with a different or unique advertiser.

12. The system of claim 10 further comprising a second transparent window within a portion of the opaque rotating top label, the second transparent window allowing at least one of the first, second, or third advertisements to be visible through the second transparent window.

13. The system of claim 12, wherein the first and second transparent windows allow at least two of the first, second, or third advertisements to be visible.

14. The system of claim 10 further comprising a third transparent window within a portion of the opaque rotating top label, the third transparent window allowing at least one of the first, second, or third advertisements to be visible through the third transparent window.

15. The system of claim 14, wherein the first, second and third transparent windows allow all three of the advertisements to be visible.

16. The system of claim 15, wherein each transparent window allows at least a portion of a single advertisement to be visible.

17. A rotating label advertising system for a container, the system comprising:
a base label adhered to the container, the base label having a back surface and a front surface;
at least a first, a second, a third, and a fourth advertisement on the front surface of the base label;
an opaque rotating top label covering at least a portion of the front surface of the base label; and
a first transparent window within a portion of the opaque rotating top label, the first transparent window allowing at least one of the first, second, third or fourth advertisements to be visible through the first transparent window.

18. The system of claim 17, wherein at least two of the advertisements are associated with the same advertiser.

19. The system of claim 17 further comprising a second transparent window within a portion of the opaque rotating top label, the second transparent window allowing at least one of the first, second, third or fourth advertisements to be visible through the second transparent window.

20. The system of claim 19, wherein the first and second transparent windows allow at least two of the first, second, third or fourth advertisements to be visible.

21. The system of claim 17 further comprising a third transparent window within a portion of the opaque rotating top label, the third transparent window allowing at least one of the first, second, third or fourth advertisements to be visible through the third transparent window.

22. The system of claim 17 further comprising a fourth transparent window within a portion of the opaque rotating top label, the fourth transparent window allowing at least one of the first, second, third or fourth advertisements to be visible through the fourth transparent window.

23. The system of claim 22, wherein the first, second, third and fourth transparent windows allow all four of the advertisements to be visible.

24. The system of claim 23, wherein each transparent window allows at least a portion of a single advertisement to be visible.

25. A method for displaying advertisements on a container, the method comprising:
adhering a base label adhered to the container, the base label having a back surface and a front surface;
displaying at least a first and a second advertisement on the front surface of the base label;
covering at least a portion of the front surface of the base label with an opaque rotating top label; and
placing a first transparent window within a portion of the opaque rotating top label, the first transparent window allowing at least one of the first and second advertisements to be visible through the first transparent window.

26. The method of claim 25, wherein each of the advertisements is associated with a different or unique advertiser.

27. The method of claim 25 further comprising providing a second transparent window within a portion of the opaque rotating top label, the second transparent window allowing at least one of the first and second advertisements to be visible through the second transparent window.

28. The method of claim 27, wherein each transparent window allows at least a portion of a single advertisement to be visible.

29. The method of claim 25, wherein at least one of the advertisements comprises a coupon.

30. The method of claim 25, wherein at least one of the advertisements comprises a pictogram.

31. The method of claim 25, wherein at least one of the advertisements comprises a machine readable indicia.

32. The method of claim 31, wherein the machine readable indicia is a bar code.

33. The method of claim 31, wherein the machine readable indicia is a quick response code.

34. A method for displaying advertisements on a container, the method comprising:
adhering a base label adhered to the container, the base label having a back surface and a front surface;
displaying at least a first, a second, and a third advertisement on the front surface of the base label;
covering at least a portion of the front surface of the base label with an opaque rotating top label; and
placing a first transparent window within a portion of the opaque rotating top label, the first transparent window allowing at least one of the first, second, or third advertisements to be visible through the first transparent window.

35. The method of claim 34, wherein each of the advertisements is associated with a different or unique advertiser.

36. The method of claim 34 further comprising providing a second transparent window within a portion of the opaque rotating top label, the second transparent window allowing at least one of the first, second, or third advertisements to be visible through the second transparent window.

37. The method of claim 36, wherein the first and second transparent windows allow at least two of the first, second, or third advertisements to be visible.

38. The method of claim 34 further comprising providing a third transparent window within a portion of the opaque rotating top label, the third transparent window allowing at least one of the first, second, or third advertisements to be visible through the third transparent window.

39. The method of claim 38, wherein the first, second and third transparent windows allow all three of the advertisements to be visible.

40. The method of claim 39, wherein each transparent window allows at least a portion of a single advertisement to be visible.

41. A method for displaying advertisements on a container, the method comprising:
adhering a base label to the container, the base label having a back surface and a front surface;
displaying at least a first, a second, a third, and a fourth advertisement on the front surface of the base label;
covering at least a portion of the front surface of the base label with an opaque rotating top label; and
placing a first transparent window within a portion of the opaque rotating top label, the first transparent window allowing at least one of the first, second, third or fourth advertisements to be visible through the first transparent window.

42. The method of claim 41, wherein at least two of the advertisements are associated with the same advertiser.

43. The method of claim 41 further comprising providing a second transparent window within a portion of the opaque rotating top label, the second transparent window allowing at least one of the first, second, third or fourth advertisements to be visible through the second transparent window.

44. The method of claim 43, wherein the first and second transparent windows allow at least two of the first, second, third or fourth advertisements to be visible.

45. The method of claim 41 further comprising providing a third transparent window within a portion of the opaque rotating top label, the third transparent window allowing at least one of the first, second, third or fourth advertisements to be visible through the third transparent window.

46. The method of claim 41 further comprising providing a fourth transparent window within a portion of the opaque rotating top label, the fourth transparent window allowing at least one of the first, second, third or fourth advertisements to be visible through the fourth transparent window.

47. The method of claim 46, wherein the first, second, third and fourth transparent windows allow all four of the advertisements to be visible.

48. The method of claim 47, wherein each transparent window allows at least a portion of a single advertisement to be visible.
